(19) United States
(12) Patent Application Publication
(10) Pub. No.: US 2010/0259514 A1
(43) Pub. Date: Oct. 14, 2010

(54) FLEXIBLE FILM, DISPLAY DEVICE HAVING THE SAME AND METHOD OF FABRICATING THE DISPLAY DEVICE

(76) Inventors: Han Bitt Joo, Chungju-si (KR); Gyung Rae Kim, Chungju-si (KR); Kwang Won Lee, Chungju-si (KR)

Correspondence Address: BIRCH STEWART KOLASCH & BIRCH, PO BOX 747, FALLS CHURCH, VA, 22040-0747, US

(21) Appl. No.: 12/746,366

(22) PCT Filed: Apr. 4, 2008
(86) PCT No.: PCT/KR08/01931

§ 371 Date: Jun. 4, 2010

(30) Foreign Application Priority Data
Dec. 6, 2007 (KR) 10-2007-0126325

(51) Int. Cl. G09G 5/00; B32B 15/08; B32B 37/06

(52) U.S. Cl. 345/204; 428/624; 428/626; 156/308.2

(57) ABSTRACT

A flexible film, a display device and a method of fabricating a display device are disclosed. The flexible film includes a polyimide film and first and second metal films formed on the polyimide film. The display device includes a panel, a driver for driving the panel, a flexible film having a circuit pattern and disposed between the panel and the driver, and a conductive film electrically connecting the panel and the driver with the flexible film. Because the metal films are formed on the polyimide film with cleaved imide rings, plating properties, adhesion strength (bond strength) and heat resistance can be improved, and a fine circuit pattern can be easily implemented.

### TECHNICAL FIELD

The present invention relates to a flexible film, a display device having the same, and a method of fabricating the display device, and more particularly, to a flexible film comprising a polyimide film with imide ring opened, a first metal film, and a second metal film, and having a good plating property, bonding strength, and heating resistance, a display device having the same and a method of fabricating the display device.

### BACKGROUND ART

As a flat panel display technology is advanced, various types of flat panel displays such as a liquid crystal display (LCD), a plasma display panel (PDP), an organic light emitting device (OLED), and the like have been developed.

### DISCLOSURE

### Technical Problem

A purpose of the present invention is to provide a flexible film having good heat resistance, plating properties, and bonding strength, on which a fine circuit pattern can be easily printed, by comprising a metal film disposed on a polyimide film with an imide ring opened, a display device having the same, and a method of fabricating the display device.

### Technical Solution

To achieve the above purpose, there is provided a flexible film comprising: a polyimide film with an imide ring opened; a first metal film disposed on the polyimide film; and a second metal film disposed on the first metal film, wherein a thickness of the polyimide film is about 10 μm to 40 μm and a total thickness of the first metal film and the second metal film is about 0.5 μm to 30 μm.

To achieve the above purpose, there is also provided a display device comprising: a panel displaying an image; a driving unit driving the panel; a flexible film having a circuit pattern and disposed between the panel and the driving unit; and a conductive film electrically connecting the panel or the driving unit to the flexible film, wherein the flexible film comprises a polyimide film, a first metal film disposed on the polyimide film, and a second metal film disposed on the first metal film.

To achieve the above purpose, there is also provided a method of fabricating a display device comprising: disposing conductive film on a portion of a panel or a driving unit; aligning a flexible film on the conductive film; and pressing and heating a portion of the flexible film for attaching the flexible film to the conductive film.

### ADVANTAGEOUS EFFECTS

According to the present invention, the first metal film and the second metal film are disposed on the polyimide film with imide ring opened. Thus, the heat resistance, the bonding strength and plating properties of the flexible film can be improved and the fine circuit pattern can be easily printed.

### DESCRIPTION OF DRAWINGS

The above and other features and advantages of the present invention will become more apparent by describing in detail preferred embodiments thereof with reference to the attached drawings in which:

FIG. 1 illustrates a cross-sectional view of a flexible film according to an embodiment of the present invention;

FIG. 2 illustrates a cross-sectional view of a flexible film according to another embodiment of the present invention;

FIGS. 3a and 3b illustrate a display device having flexible films, according to an embodiment of the present invention;

FIGS. 4 to 7 illustrate conductive balls included in conductive films according to an embodiment of the present invention;

FIG. 8 illustrates a flow chart of a method of fabricating a display device according to an embodiment of the present invention; and

FIGS. 9 to 14 illustrate a method of fabricating the display device according to an embodiment of the present invention sequentially.

### MODE FOR INVENTION

The present invention will hereinafter be described in detail with reference to the accompanying drawings in which exemplary embodiments of the invention are shown.

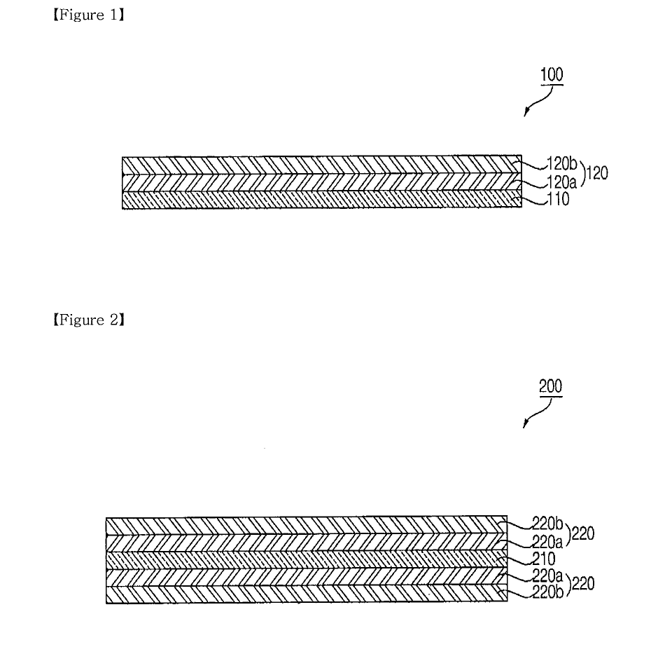

FIG. 1 illustrates a cross-sectional view of a flexible film according to an embodiment of the present invention. In the embodiment of the present invention, it is assumed that the flexible film has a single side structure. With reference to FIG. 1, the flexible film 100 according to the exemplary embodiment of the present invention may comprise a first metal film 120a disposed on a polyimide film 110 and a second metal film 120b disposed on the first metal film 120a.

The flexible film 100 according to the exemplary embodiment of the present invention may further comprise a protection layer attached on the second metal film 120b with an adhesion layer interposed therebetween. The protection layer protects a circuit pattern printed on the metal film 120 including the first metal film 120a and the second metal film 120b.

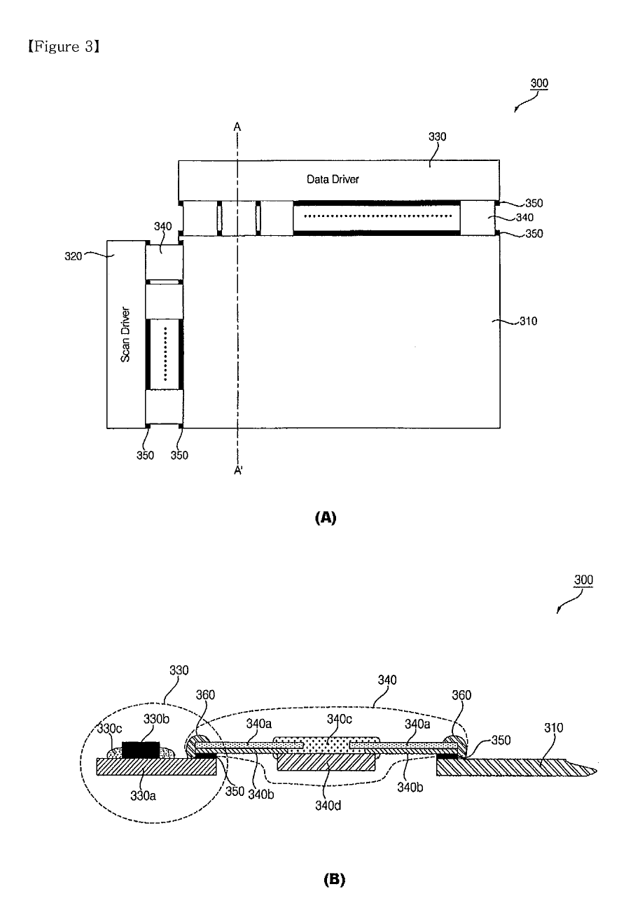

FIG. 2 illustrates a cross-sectional view of a flexible film with a double-side structure. With reference to FIG. 2, the flexible film 200 according to the exemplary embodiment of the present invention may comprise first metal films 220a disposed on a polyimide film 210, second metal films 220b disposed on the first metal films 220a

Protection layers can be attached on the second metal films 220b with adhesion layers interposed therebetween. The flexible film 200 may further comprise a kapton tape attached on a portion of the protection layer. The kapton tape can prevent a short circuit of a circuit pattern printed on the metal film 220 including the first metal film 220a and the second metal film 220b.

The polyimide films 110 and 210 of the flexible films 100 and 200 as shown in FIGS. 1 and 2, which are made of a material with insulation property, are base films of the flexible films 100 and 200. The first metal films 120a and 220a disposed on the polyimide films 110 and 210 may comprise at least one of gold, nickel, chromium, and copper, and in this case, copper is commonly used because of its advantage of manufacturing costs.

The thickness of the polyimide films 110 and 210 may be about 10 μm to 40 μm. If the thickness of the polyimide films 110 and 210 is smaller than 10 μm, a peel strength and a reliability of the flexible films 100 and 200 are deteriorated. And, if the thickness of the polyimide films 110 and 210 is larger than 40 μm, a flexibility of the flexible films 100 and 200 are deteriorated. So, the thickness of the polyimide films 110 and 210 is about 10 μm to 40 μm, and preferably is about 35 μm to 38 μm.

The metal films 120 and 220 are disposed on the polyimide films 110 and 210 and, in this case, before the metal films 120 and 220 are disposed, the imide rings included in the polyimide films 110 and 210 can be opened. By opening the imide rings of the polyimide films 110 and 210, adhesiveness between the metal films 120 and 220, and the polyimide films 110 and 210 can be strengthened to increase peel strength of the flexible films 100 and 200.

In addition, palladium may be applied as a catalyst onto the opened imide rings of the polyimide films 110 and 210 to increase a reaction speed. In this case, the imide rings-opened polyimide films 110 and 210 may be immersed in a solution containing palladium chloride (PdCl) and hydrochloric acid to apply palladium to the polyimide films 110 and 210.

The metal films may be disposed by using sputtering, laminating or plating method, and in the exemplary embodiment of the present invention, it is assumed that the plating method is used. In particular, the first metal films 120a and 220a may be disposed according to an electroless plating method, and the second metal films 120b and 220b may be disposed according to an electro-plating method.

The metal films 120 and 220 may be disposed with a thickness of about 0.5 mm to 30 mm. A thickness of the first metal films 120a and 220a may be greater than 0 μm and equal or less than 0.2 μm. If the first metal films 120a and 220a are disposed to be thicker than 0.2 mm, electric resistance would be reduced, and as a plating time is lengthened, the peel strength of the first metal films 120a and 220a may be reduced due to accessory ingredients of an electroless plating solution that plates the first metal films 120a and 220a. Thus, preferably, the first metal films 120a and 220a are disposed with a thickness of 0.1 mm.

The second metal films 120b and 220b may be disposed on the first metal films 120a and 220a according to the electro-plating method. In detail, the flexible films 100 and 200 including the first metal films 120a and 220a are immersed in an electro-plating solution containing metallic ions aimed for forming the second metal films 120b and 220b, and the metallic ions are precipitated as metal to thus form the second metal films 120b and 220b. In this case, time required for the flexible films 100 and 200 to be immersed in the electroplating solution, and an amount of current applied to the plating process are controlled according to a thickness of the second metal films 120b and 220b.

The second metal films 120b and 220b may be disposed with a thickness of about 0.5 mm to 30 mm. If the thickness of the second metal films 120b and 220b is smaller than 0.5 mm, the internal bond strength is reduced to degrade reliability of a product, while if it is larger than 30 mm, the flexibility of the flexible films 100 and 200 may deteriorate. Thus, the second metal films 120b and 220b are formed with the thickness within the range of about 0.5 mm to 30 mm.

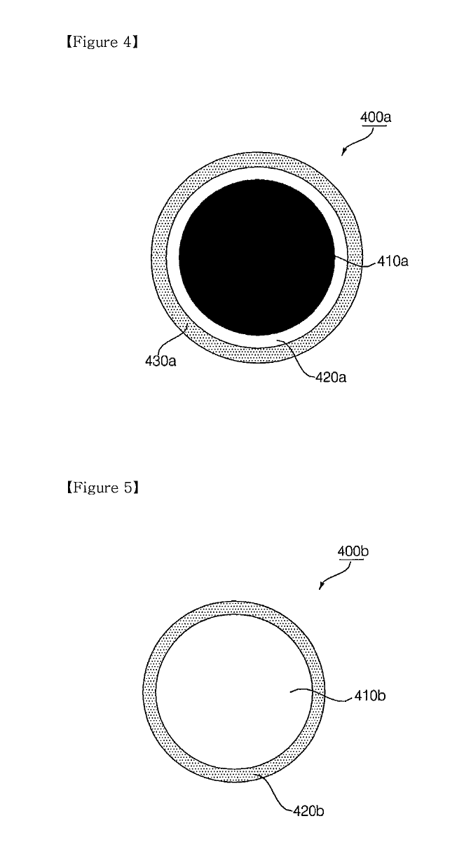

FIGS. 3a and 3b illustrate a display device according to an embodiment of the present invention. The display device according to the embodiment of the present invention is a flat panel display device which can be an LCD, a PDP or an OLED. With reference to FIG. 3a, the display device 300 according to the embodiment of the present invention comprises a panel 310 displaying an image, driving units 320 and 330 driving the panel 310, and flexible films 340 having a certain circuit pattern printed thereon and transferring signals applied by the driving units 320 and 330 to the panel 310. The flexible films 340 may be connected with the driving units 320 and 330 and the panel 310 by conductive films 350 with adhesiveness.

The panel 310 includes a plurality of pixels formed on a substrate and displays an image according to signals applied from the driving units 320 and 330. The display device 300 may be an active matrix display device or a passive matrix display device depending on how the pixels of the panel 310 are driven.

The driving units 320 and 330 are units for applying image signals to the panel 310, and comprise a scan driver 320 and a data driver 330, respectively. The scan driver 320 applies scan signals in a row direction to the pixels of the panel 310. As the data driver 330 applies data signals in synchronization with the scan signals applied by the scan driver 310, an image can be displayed on the panel 310.

The driving units 320 and 330 may be connected with the panel 310 through the flexible films 340. The flexible films 340, which is formed by disposing a metal film on a insulation film and printing a circuit pattern on the metal film, may transfer signals applied from the driving units 320 and 330 to scan electrodes disposed in a horizontal direction and data electrodes disposed in a vertical direction on the panel 310.

The base film of the flexible film 340 comprises insulation material. The insulation film of the flexible film 340 may be a polyimide film and the metal films may comprise at least one of nickel, gold, chromium, and copper, etc. The polyimide film used as the base film may have the thickness of about 10 μm to 40 μm in consideration of flexibility and reliability of the product.

The metal film disposed on the polyimide film may comprise a first metal film and a second metal film. The first metal film may be disposed with a thickness greater than 0 and equal or less than 0.2 μm. The first metal film may be disposed by using an electroless plating method. If the thickness of the first metal film is greater than 0.2 mm, the polyimide film may be damaged by accessory ingredients of an electroless plating solution used for the electroless plating, so, preferably, the first metal film has the thickness of 0.2 mm or smaller. If, however, the first metal film is disposed to be too thin, when the second metal film is electroplated, resistance would be increased, interrupting an electro-plating. Thus, the first metal film should be formed with such a thickness as to ensure there is no non-plated portion.

The second metal film may be disposed by using the electroplating method and comprise at least one of gold and copper. In consideration of the flexibility and reliability of the flexible films 340 and easiness of printing of the circuit pattern, preferably, the second metal film may be deposed so that a total thickness of the first metal film and the second metal film is about 0.5˜30 mm.

The flexible films 340 may include a circuit pattern and an IC (Integrated Circuit) required for transferring a driver signal according to a TCP (Table Carrier Package) method. In particular, the flexible film 340 between the scan driver 320 and the panel 310 may be a COF (Chip-On-Film) that has excellent flexibility and reliability and a pitch of the product of 40 mm or smaller. In a different example, the flexible film 340 between the data driver 330 and the panel 310 may also be the COF.

The flexible films 340 may be connected with the panel 310 and the driving units 320 and 330 by a conductive film 350. In one example, the conductive film 350 may be anisotropic conductive films (ACF) and include conductive balls with a diameter of 5 mm or smaller. The conductive film 350 are disposed on edge portions of the panel 310 and the driving units 320 and 330, and the flexible films 340 are disposed on the conductive film 350 and then heated and pressed so as to be connected with the panel and the driving units 320 and 330.

The conductive balls of the conductive film 350 are connected with the panel 310 and the driving units 320 and 330, and the circuit pattern of the flexible film 340, and transfer a signal. The conductive balls may include a metallic layer with conductivity which may comprise at least one of nickel, gold, and copper. In addition, the conductive balls may further include an insulation layer made of plastic at an inner or outer side of the metallic layer.

The flexible films 340 may include outer leads connected with the driving units 320 and 330 and the panel 310 and inner leads connected with the IC included in the flexible films 340. The outer leads may include an input outer lead connected with the driving units 320 and 330 and an output outer lead connected with the panel 310.

FIG. 3b is a cross-sectional view taken along line A-A? of the display device 300 in FIG. 3a. With reference to FIG. 3b, the display device 300 comprises the panel 310 displaying an image, the data driver 330 that applies an image signal to the panel 310, the flexible film 340 connecting with the data driver 330 and the panel 310, and the conductive films 350 that electrically connects the flexible film 340 to the data driver 330 and the panel 310.

According to the embodiment of the present invention, the display device 300 may further comprise a resin 360 sealing up portions of the flexible film 340 contacting the conductive films 350. The resin 360 may comprise an insulating material and serve to prevent impurities that may be introduced into the portions where the flexible film 340 contacting the conductive films 350, to thus prevent damage of a signal line of the flexible film 340 connected with the panel 310 and the data driver 330, and lengthen a life span.

Although not shown, the panel 310 may comprise a plurality of scan electrodes disposed in the horizontal direction and a plurality of data electrodes disposed to cross the scan electrodes. The data electrodes disposed in the direction A-A? are connected with the flexible film 340 via the conductive film 350 as shown in FIG. 3b in order to receive an image signal applied from the data driver 330 and thus display a corresponding image.

The data driver 330 includes a driving IC 330b formed on a substrate 330a and a protection resin 330c for protecting the driving IC 330b. The protection resin 330c may be made of a material with insulating properties and protects a circuit pattern (not shown) formed on the substrate 330a and the driving IC 330b against impurities that may be introduced from the exterior. The driving IC 330b applies an image signal to the panel 310 via the flexible film 340 according to a control signal transmitted from a controller (not shown) of the display device 300.

The flexible film 340 disposed between the panel 310 and the data driver 330 includes polyimide film 340a, metal film 340b disposed on the polyimide films 340a, an IC 340c connected with a circuit pattern printed on the metal film 340b, and a resin protection layer 340d sealing up the circuit pattern and the IC 340c.

A thickness of the polyimide film 340a is about 10 μm to 40 μm in consideration of flexibility and reliability of the flexible film 340. The metal film 340b may have a dual-layer structure and may comprise at least one of nickel, gold, chromium, and copper. When the metal film 340b has the dual-layer structure, the first metal film may be disposed according to the electroless plating method, while the second metal film may be disposed according to the electro-plating method. The thickness of the metal film 340b is preferably about 0.5 μm to 30 μm in consideration of easiness, reliability, and flexibility in printing the circuit pattern, and easiness of the plating process.

The flexible film 340 is connected with the panel 310 and the data driver 330 via the conductive films 350. The conductive films 350 connect the circuit pattern printed on the metal film 340b of the flexible film 340 to the electrodes of the panel 310 and the circuit pattern of the data driver 330 via conductive balls.

FIGS. 4 to 7 illustrate conductive balls included in the conductive films according to an embodiment of the present invention. A diameter of conductive balls according to the embodiment of the present invention is greater than 0 and equal to or less than 5 μm, and may include at least one of metallic layers with electroconductivity.

With reference to FIG. 4, a conductive ball 400a shown as a first example according to the embodiment of the present invention may comprise an insulation layer 410a made of an insulating material such as plastic, a first metallic layer 420a formed to cover the insulation layer 410a, and a second metallic layer 430a formed to cover the first metallic layer 420a. The first metallic layer 420a may comprise at least one of nickel, gold, and copper, and the second metallic layer 430a may comprise at least one of gold and copper. In terms of the production unit cost, preferably, the first metallic layer 420a is nickel and the second metallic layer 430a is copper.

FIG. 5 shows a conductive ball 400b shown as a second example according to the embodiment of the present invention. With reference to FIG. 5, the conducive ball 400b according to the second embodiment of the present invention may include a first metallic layer 410b comprising at least one of nickel, gold, and copper, and a second metallic layer 420b formed to cover the first metallic layer 410b. The second metallic layer 420b comprises at least one of gold and copper.

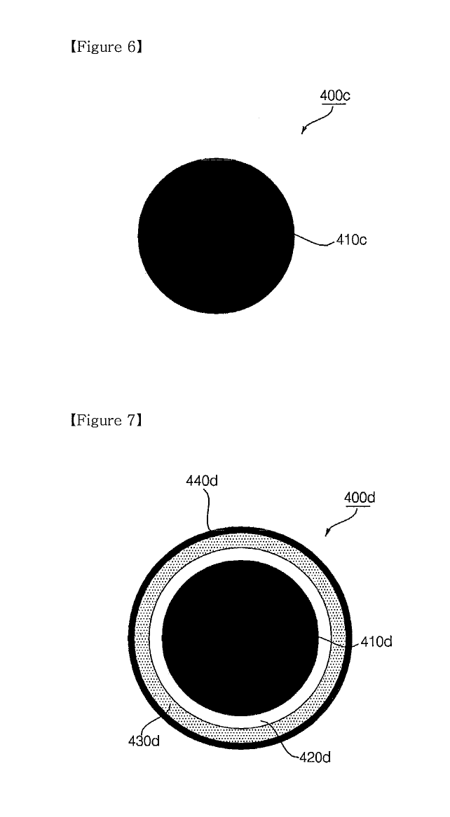

With reference to FIG. 6, a conductive ball 400c shown as a third example according to the embodiment of the present invention may include a single metallic layer 410c comprising at least one of nickel, gold, and copper. In terms of the production unit cost, the metallic layer 410c is preferably nickel or copper.

With reference to FIG. 7, a conductive ball 400d shown as a fourth example according to the embodiment of the present invention may include a first insulation layer 410d, a first metallic layer 420d formed to cover the insulation layer 410d, and a second metallic layer 430d formed to cover the first metallic layer 420d. The conductive ball 400d may further include a second insulation layer 440d at an outer side of the second metallic layer 430d.

The second insulation layer 440d is formed to be thinner than the first insulation layer 410d so that it can be destroyed when the flexible film 340 disposed on the conductive film 350 is heated and pressed. As the second insulation layer 440d is destroyed, the second metallic layer 430d can contact with the circuit pattern of the flexible film 340 and the circuit patterns of the driving units 320 and 330, and the electrodes of the panel 310, whereby the flexible film 340 can be electrically connected with the panel 310 and the driving units 320 and 330.

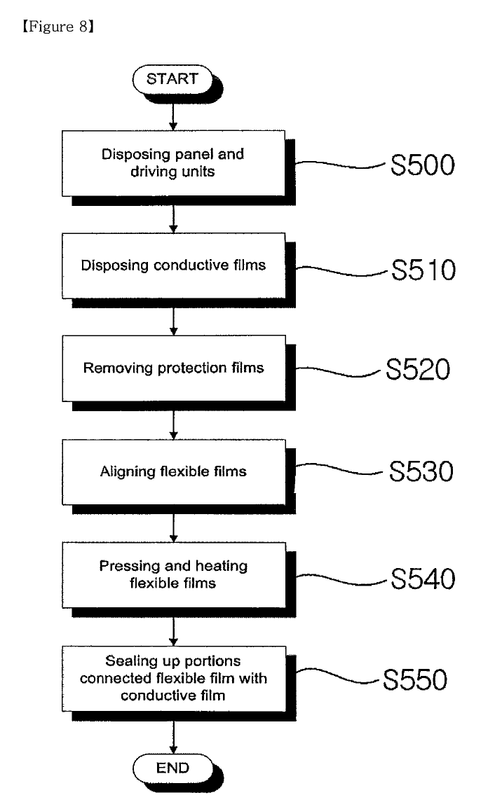

FIG. 8 illustrates a flow chart the process of a method of fabricating a display device according to an embodiment of the present invention. With reference to FIG. 8, the method for fabricating the display device 300 according to the embodiment of the present invention starts by disposing the panel 310 and the driving units 320 and 330 (S500). The panel 310 and the driving units 320 and 330 are disposed on positions at which they can be available for connection with the flexible films 340 and impurities on the panel 310 and the driving units 320 and 330 may be eliminated.

When the disposition of the panel 310 and the driving units 320 and 330 is completed, the conductive films 350 are aligned on the panel 310 and the driving units 320 and 330 (S510). The conductive films 350 may be anisotropic conductive films (ACF) and are disposed at portions where the flexible films 340 are to be attached.

When the disposition of the conductive films 350 is completed, protection films are removed from the conductive films 350 (S520) and the flexible films 340 are disposed between the panel 310 and the driving units 320 and 330 such that they contact with the conductive films 350 (S530). The flexible film 340 disposed between the scan driver 320 and the panel 310 may be the COF while the flexible film 340 disposed between the data driver 330 and the panel 310 may be the TCP or the COF.

The flexible films 340 may include outer leads connected with the electrodes on the panel 310 and the circuit patterns of the driving units 320 and 330. The flexible films 340 are disposed on the conductive films 350 such that their outer leads contact with the electrodes on the panel 310 and the circuit patterns of the driving units 320 and 330.

When the disposition of the flexible films 340 is completed, portions of the flexible films 340 disposed on the conductive films 350 are heated and pressed to attach the flexible films 340 to the panel 310 and the driving units 320 and 330 (S540). That is, when the portions of the flexible films 340 disposed on the conductive films 350 are heated and pressed, a resin with adhesiveness included in the conductive films 350 is hardened, and connect the flexible films 340 with the panel 310 and the driving units 320 and 330.

At this time, conductive balls in the conductive film 350 are disposed between outer leads of the flexible films 340 and the electrodes of the panel 310 and between the outer leads and the circuit patterns of the driving units 320 and 330, electrically connecting the flexible films 340 with the panel 310 and the driving units 320 and 330. The conductive balls may comprise at least one of nickel, gold, and copper, and transmit a signal from the driving units 320 and 330 to the panel 310 via the flexible films 340.

The attachment step S540 may include a first attachment step of heating and pressing the portions of the flexible films 340 for one to three seconds at a temperature of about 60° C. to 100° C. and a second attachment step of heating and pressing the portions of the flexible films 340 for five to fifteen seconds at a temperature of about 150° C. to 200° C. Through the first and second attachment steps, the conductive films 350 may increase hardening density, and accordingly, the adhesion of the flexible films 340, the panel 310 and the driving units 320 and 330 can be improved.

When the attachment step S540 according to the heating and pressing is completed, the portions of the flexible films 340 connected with the panel 310 and the driving units 320 and 330 by the conductive films 350 can be sealed with the resin 360. (S550). By sealing the connection portions, the connection portions can be protected against impurities such as dust or debris that can be introduced from the exterior and prevented from being damaged.

FIGS. 9 to 14 illustrate a method of fabricating the display device according to an embodiment of the present invention sequentially. With reference to FIG. 9, the method of fabricating a display device 600 starts by disposing conductive films 650 on edge portions of a panel 610 and driving units 620 and 630. Before disposing the conductive films 650, impurities may be eliminated from the regions of the panel 610 and the driving units 620 and 630 where the conductive films 650 are to be disposed. The conductive films 650 may be anisotropic conductive films (ACF), and the driving units may comprise a scan driver 620 and a data driver 630.

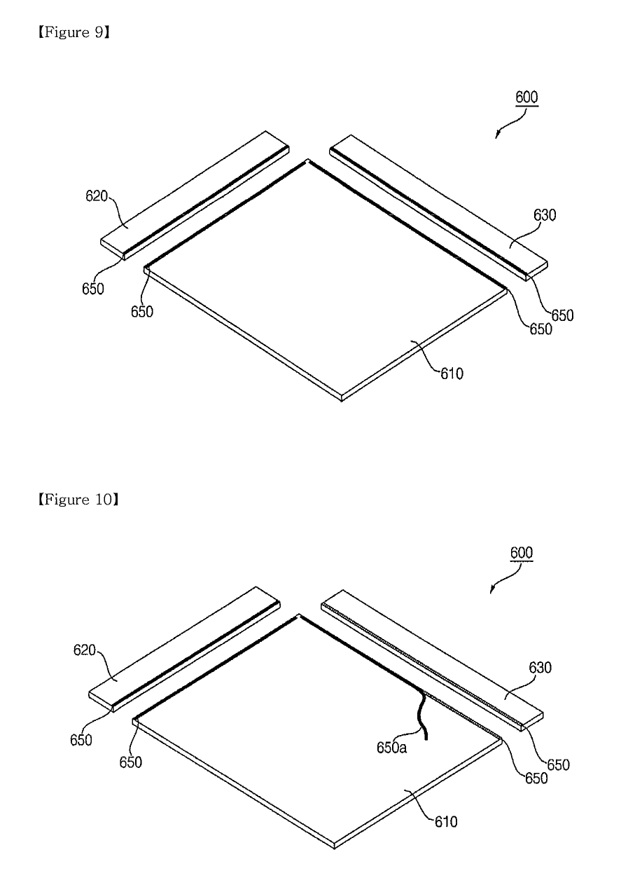

With reference to FIG. 10, the conductive films 650 are disposed and protection films 650a are removed from the conductive films 650. The removal of the protection films 650a exposes an adhesive insulation resin including conductive balls.

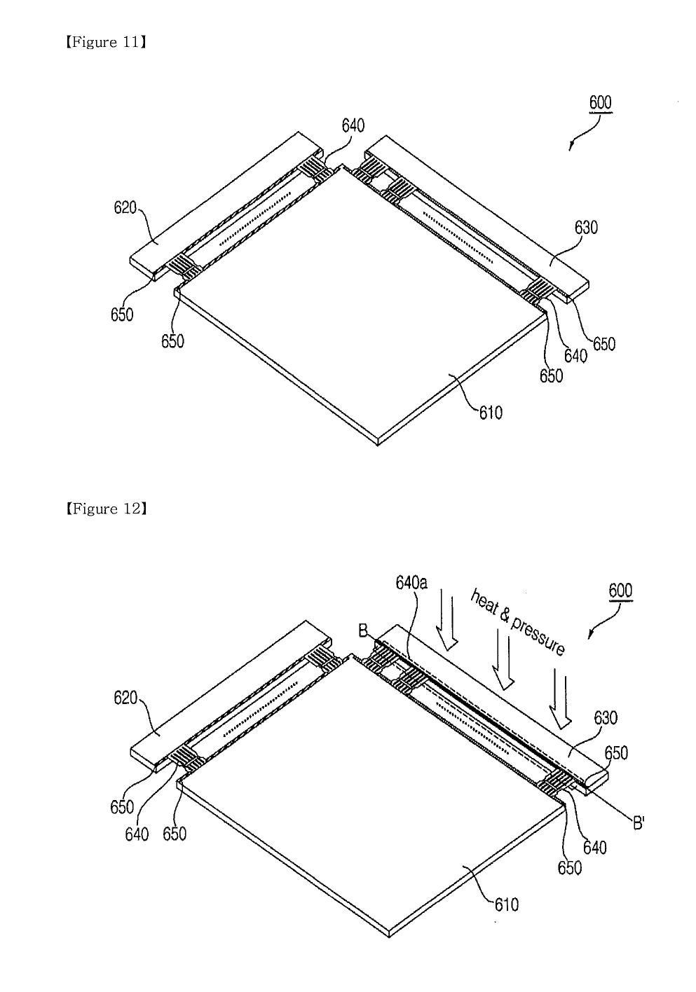

After the protection films 650a are removed, as shown in FIG. 11, flexible films 650 are disposed to be positioned on the conductive films 650 attached at the panel 610 and the driving units 620 and 630. The flexible films 640 may be a flexible copper clad laminate (FCCL) including a metal film on an insulation film made of polyimide or the like and printing a circuit pattern on the metal film.

The flexible films 640 may include outer leads connected with electrodes formed on the panel 610 and circuit patterns formed on the driving units 620 and 630. The outer leads may be formed at pitches of about 40 mm to 70 mm, and in case where the flexible films 640 are COFs, the outer leads may be formed at pitches of 40 mm or smaller.

When the disposition of the flexible films 640 is completed, portions 640a of the flexible films 640 disposed on the conductive films 650 are heated and pressed to attach the flexible films 640 to the panel 610 and the driving units 620 and 630. As shown in FIG. 12, when the portions 640a disposed on the conductive films 650 are heated and pressed, an adhesive insulation resin in the conductive films 650 is hardened. When the adhesive insulation resin is hardened, conductive balls included in the conductive films 650 become disposed between the outer leads of the flexible films 640 and the electrodes of the panel 610 and between the outer leads and the circuit patterns of the driving units 620 and 630, electrically connecting the flexible film 640 with the panel 610 and the driving units 620 and 630.

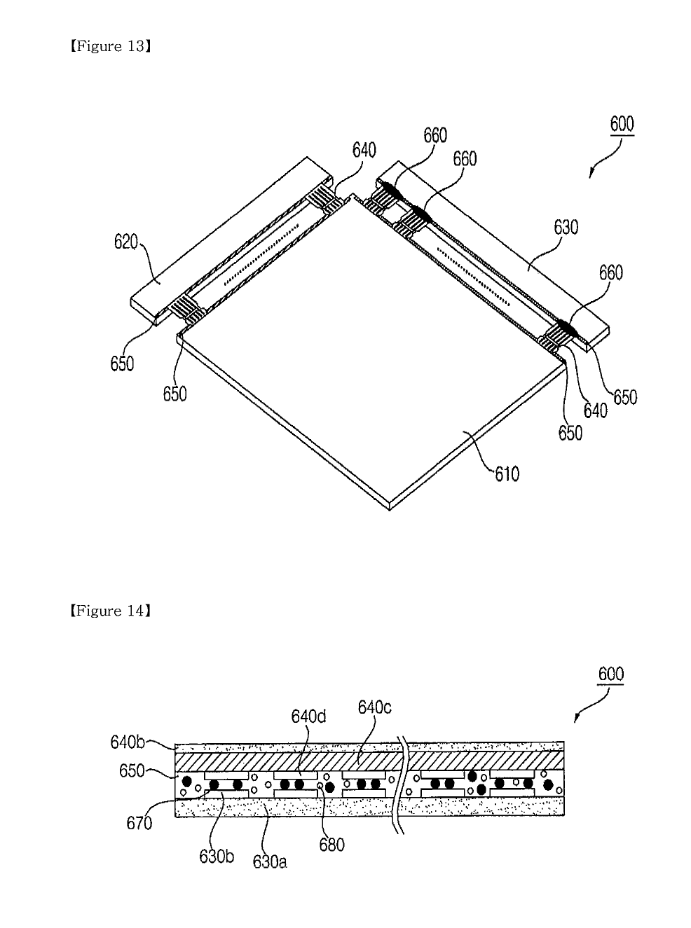

When the flexible films 640 are attached with the panel 610 and the driving units 620 and 630 through the conductive films 650, the flexible films 640 attached with the conductive films 650 can be sealed with the resin 660. With reference to FIG. 13, because the portions of the flexible films 640 attached to the conductive films 650 can be sealed with the resin 660, impurities that may be introduced from the exterior can be blocked.

FIG. 14 is a cross-sectional view taken along line B-B? of the display device 600 in FIG. 12. With reference to FIG. 14, after the conductive film 650 is disposed, the flexible film 640 disposed on the conductive film 650 is heated and pressed to allow outer leads 640d of the flexible film 640 and the circuit pattern 630b on a substrate 630a of the data driver 630 to be connected through conductive balls 670 included in the conductive film 650.

A diameter of the conductive balls is equal to or less than 5 μm. If the diameter of the conductive balls is larger than 5 μm, a short circuit phenomenon may occur due to the conductive balls 670 at a region where the outer leads 640d of the flexible films 640 and the circuit pattern 630b of the data driver 630 are not connected. Thus, the diameter of the conductive balls is preferably 5 mm or smaller.

Alternatively, in order to prevent the short circuit phenomenon due to the conductive balls 670, insulating balls 680 having a diameter smaller than that of the conductive balls 670 may be included in the conductive film 650 or an insulation layer which is easily destroyed by pressure can be formed at an outer side of the metallic layer of the conductive balls 670.

The foregoing description of the preferred embodiments of the present invention has been presented for the purpose of illustration and description. It is not intended to be exhaustive or to limit the invention to the precise form disclosed, and modifications and variations are possible in light of the above teachings or may be acquired from practice of the invention. It is intended that the scope of the invention be defined by the claims appended hereto and their equivalents.

1. A flexible film comprising:
a insulation film with an imide ring opened;
a first metal film disposed on the insulation film; and
a second metal film disposed on the first metal film,
wherein a thickness of the insulation film is about 10 μm to 40 μm, and a total thickness of the first metal film and the second metal film is about 0.5 μm to 30 μm.

2. The flexible film of claim 1, further comprising a palladium on the insulation film.

3. The flexible film of claim 1, wherein a thickness of the first metal film is greater than 0 and equal or less than 0.2 μm.

4. The flexible film of claim 1, wherein a thickness of the second metal film is about 0.5 μm to 30 μm.

5. The flexible film of claim 1, wherein the first metal film comprises at least one of gold, nickel, chrome, and copper.

6. The flexible film of claim 1, wherein the second metal film comprises at least one of gold and copper.

7. The flexible film of claim 1, wherein the insulation film comprises a polyimide film.

8. A display device comprising:
a panel displaying an image;
a driving unit driving the panel;
a flexible film having a circuit pattern and disposed between the panel and the driving unit; and
a conductive film electrically connecting the panel or the driving unit to the flexible film,
wherein the flexible film comprising a insulation film, a first metal film disposed on the insulation film, and a second metal film disposed on the first metal film.

9. The display device of claim 8, wherein the flexible film is a flexible copper clad laminate.

10. The display device of claim 8, wherein a thickness of the insulation film is about 10 μm and 40 μm, and a total thickness of the first metal film and the second metal film is about 0.5 μm to 30 μm.

11. The display device of claim 10, wherein a thickness of the first metal film is greater than 0 and equal to or less than 0.2 μm.

12. The display device of claim 8, wherein the conductive film is an anisotropic conductive film.

13. The display device of claim 8, wherein the conductive film comprises an adhesive attaching the panel or the driving unit to the flexible film.

14. The display device of claim 8, wherein the conductive film comprises conductive balls electrically connecting the panel or the driving unit to the flexible film.

15. The display device of claim 8, further comprising a resin sealing up a portion of the flexible film contacting the conductive film.

16. The display device of claim 8, wherein the insulation film comprises polyimide film.

17. A method of fabricating a display device, the method comprising:
disposing conductive film on a portion of a panel or a driving unit;
aligning a flexible film on the conductive film; and
pressing and heating a portion of the flexible film for attaching the flexible film to the conductive film.

18. The method of claim 17, further comprising eliminating impurities on the panel and the driving unit.

19. The method of claim 17, further comprising sealing up a portion of the flexible film contacting the conductive film.

20. The method of claim 17, wherein the pressing and heating attaches the flexible film to the portion of the panel or the driving unit disposed the conductive film.

21. The method of claim 17, wherein the flexible film is a flexible copper clad laminate.

22. The method of claim 17, wherein the conductive film is an anisotropic conductive film.

23. The method of claim 17, wherein the pressing and heating comprises:
a first pressing and heating the portion of the flexible film at a temperature of 60-100° C. for one to three seconds; and
a second pressing and heating the portion of the flexible film at a temperature of 150-250° C. for five to fifteen seconds.
